(19) United States
(12) Patent Application Publication
(10) Pub. No.: US 2018/0309142 A1
(43) Pub. Date: Oct. 25, 2018

(54) GAS HEATING UNIT FOR FUEL CELL AND FUEL CELL STACK INCLUDING THE SAME

(71) Applicant: IUCF-HYU (INDUSTRY-UNIVERSITY COOPERATION FOUNDATION HANYANG UNIVERSITY), Seoul (KR)

(72) Inventors: Hee Sung YOON, Pohang-si (KR); Ungyu PAIK, Seoul (KR); Inyoung Jang, Seoul (KR); Chanho KIM, Seoul (KR); Sungmin KIM, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 16/022,024

(22) Filed: Jun. 28, 2018

Related U.S. Application Data
(63) Continuation of application No. PCT/KR2016/015508, filed on Dec. 29, 2016.

(30) Foreign Application Priority Data
Dec. 29, 2015 (KR) 10-2015-0188052

(51) Int. Cl. H01M 8/04014; H01M 8/0258; H01M 8/2404; H01M 8/12

(52) U.S. Cl. CPC H01M 8/04014; H01M 8/12; H01M 8/2404; H01M 8/0258

(57) ABSTRACT

Provided is a gas heating unit for a fuel cell. The gas heating unit includes a supply gas inlet for receiving a supply gas before pre-heating, a plurality of pre-heating plates having openings and configured to pre-heat the supply gas, a plurality of support plates supporting the pre-heating plates and having openings, and a supply gas outlet for supplying the pre-heated supply gas to a fuel cell stack module. The pre-heating plates and the support plates are alternately stacked, and the openings of the pre-heating plates and the openings of the support plates provide a path to the supply gas.

### CROSS-REFERENCE TO RELATED APPLICATION

This application is a continuation of pending International Application No. PCT/KR2016/015508, which was filed on Dec. 29, 2016 and claims priority to Korean Patent Application No. 10-2015-0188052, filed on Dec. 29, 2015, in the Korean Intellectual Property Office, the disclosures of which are hereby incorporated by reference in their entireties.

### BACKGROUND

### 1. Field

The present disclosure herein relates to a gas heating unit for a fuel cell and a fuel cell stack including the same. More particularly, the present disclosure relates to a gas heating unit configured to supply a pre-heated gas into a stack module of a fuel cell through openings formed in pre-heating plates and support plates alternately stacked, and a fuel cell stack including the same.

### 2. Description of the Related Art

A fuel cell is an apparatus for converting a change in free energy by electrochemical reaction of fuel with oxygen into electric energy. A solid oxide fuel cell using an ion conductive oxide as an electrolyte may operate at a high temperature of about 600 degrees Celsius to about 1000 degrees Celsius to produce electric energy and heat energy and may have the highest energy conversion efficiency among developed fuel cells. Since the solid oxide fuel cell operates at the high temperature, it may use various raw materials (e.g., natural gas and coal gas) as a fuel. In addition, since the solid oxide fuel cell uses a solid electrolyte and a solid electrode, the solid oxide fuel cell may be used for a long time without corrosion and loss of a material.

Recently, a metal separation plate constituting a unit of a fuel cell stack has been studied to increase efficiency of the solid oxide fuel cell. In particular, a structure and a material of the metal separation plate have been actively studied to improve electrical conductivity of the metal separation plate.

For example, Korean Patent Publication No. KR20150007190A (Applicant: Korea institute of energy research, Application No. KR20130146459A) discloses a fabrication technique on ceramic powder for a protective layer of a metal separation plate of a solid oxide fuel cell, which is capable of minimizing oxidation of the metal separation plate and of improving electrical conductivity of the metal separation plate. According to this art, slurry is formed by mixing the ceramic powder with a binder, a nonionic surfactant, a dispersant and a solvent, a surface of the metal separation plate is coated with the slurry, and then, the metal separation plate coated with the slurry is dried at room temperature to form the protective layer on the metal separation plate.

However, to improve reliability and life span of the solid oxide fuel cell as well as the efficiency of the solid oxide fuel cell, it may be required to study a method capable of minimizing physical damage caused by a thermal shock in the solid oxide fuel cell.

### SUMMARY

The present disclosure may provide a gas heating unit for a fuel cell which is capable of reducing a thermal shock of the fuel cell, and a fuel cell stack including the same.

The present disclosure may also provide a gas heating unit for a fuel cell, which is capable of improving a reforming efficiency of a fuel gas, and a fuel cell stack including the same.

The present disclosure may further provide a gas heating unit for a fuel cell which has excellent thermal conductivity, and a fuel cell stack including the same.

The present disclosure may further provide a gas heating unit for a fuel cell which has excellent mechanical strength characteristics, and a fuel cell stack including the same.

The present disclosure may further provide a gas heating unit for a fuel cell which has excellent processability, and a fuel cell stack including the same.

In an aspect, a gas heating unit for a fuel cell may include a supply gas inlet for receiving a supply gas before pre-heating, a plurality of pre-heating plates having openings and configured to pre-heat the supply gas, a plurality of support plates supporting the pre-heating plates and having openings, and a supply gas outlet for supplying the pre-heated supply gas to a fuel cell stack module. The pre-heating plates and the support plates may be alternately stacked, and the openings of the pre-heating plates and the openings of the support plates may provide a path to the supply gas.

In an embodiment, the opening of the support plate disposed between one pre-heating plate and another pre-heating plate of the plurality of pre-heating plates may provide a section of a supply gas path for the supply gas, which extends in an extending direction of the pre-heating plate, and the opening of the pre-heating plate disposed between one support plate and another support plate of the plurality of support plates may provide another section of the supply gas path for the supply gas, which extends in a thickness direction of the pre-heating plate.

In an embodiment, the supply gas path may include a first flow section in which the supply gas flows in a first direction along a surface of the pre-heating plate through the opening of one of the plurality of support plates, a second flow section in which the supply gas flows in a second direction parallel to the thickness direction of the pre-heating plate through the opening of the pre-heating plate, and a third flow section in which the supply gas flows in a third direction opposite to the first direction along a surface of the pre-heating plate through the opening of another support plate adjacent to the one support plate.

In an embodiment, the first, second and third flow sections may constitute a basic unit section, and the supply gas path may include a plurality of the basic unit sections.

In an embodiment, the plurality of pre-heating plates and the plurality of support plates may further include openings for an exhaust gas path through which a high-temperature exhaust gas exhausted from the fuel cell stack module flows.

In an embodiment, the exhaust gas path may extend in one direction.

In an embodiment, areas of the openings of the support plates providing the supply gas path may be greater than areas of the openings of the support plates providing the exhaust gas path.

In an embodiment, the exhaust gas path may intersect the supply gas path in the extending direction of the pre-heating plate such that the high-temperature exhaust gas flowing through the exhaust gas path pre-heats the supply gas.

In an embodiment, a flowing direction of the exhaust gas flowing through the exhaust gas path may be opposite to a flowing direction of the supply gas flowing through the supply gas path with the pre-heating plate interposed therebetween.

In an embodiment, a temperature of the exhaust gas flowing through the exhaust gas path may be higher than a temperature of the pre-heating plate, and the temperature of the pre-heating plate may be higher than a temperature of the supply gas flowing through the supply gas path.

In an embodiment, the supply gas may include fuel, and a catalyst layer for reforming the fuel may be formed on a surface of the pre-heating plate along which the supply gas including the fuel flows.

In an embodiment, the support plate may include a cut-off pattern for supporting the pre-heating plate, and the cut-off pattern of the support plate may not overlap with the opening of the pre-heating plate stacked on the support plate.

In an aspect, a fuel cell stack may include the gas heating unit for a fuel cell according to some embodiments of the inventive concepts. The gas heating unit for a fuel cell may be coupled to the fuel cell stack module by a pressing means pressing the gas heating unit in a stacking direction of the pre-heating plates and the support plates.

### BRIEF DESCRIPTION OF THE DRAWINGS

FIG. 1 is a schematic view illustrating a method of manufacturing a gas heating unit for a fuel cell, according to an embodiment of the inventive concepts.

FIG. 2 is a schematic view illustrating a process of supplying/exhausting a supply gas and an exhaust gas into/from a fuel cell stack module through a gas heating unit for a fuel cell, according to an embodiment of the inventive concepts.

FIG. 3 is a schematic view illustrating a method of manufacturing a gas heating unit for a fuel cell, according to another embodiment of the inventive concepts.

FIG. 4 is a schematic view illustrating a process of supplying/exhausting a supply gas and an exhaust gas into/from a fuel cell stack module through a gas heating unit for a fuel cell, according to another embodiment of the inventive concepts.

FIGS. 5 and 6 are plan views illustrating support plates of gas heating units for a fuel cell, according to some embodiments of the inventive concepts.

FIG. 7 is a schematic view illustrating a first pre-heating plate of a gas heating unit for a fuel cell, according to some embodiments of the inventive concepts.

FIG. 8 is a schematic view illustrating a first pre-heating plate, having a catalyst layer, of a gas heating unit for a fuel cell, according to some embodiments of the inventive concepts.

FIG. 9 is a schematic view illustrating a second pre-heating plate of a gas heating unit for a fuel cell, according to some embodiments of the inventive concepts.

FIG. 10 is a schematic view illustrating a second pre-heating plate, having a catalyst layer, of a gas heating unit for a fuel cell, according to some embodiments of the inventive concepts.

FIG. 11 is a perspective view illustrating a fuel cell stack including a gas heating unit for a fuel cell, according to some embodiments of the inventive concepts.

FIG. 12 is a view illustrating an application example of a power-generating fuel cell stack which uses a fuel cell stack including a gas heating unit for a fuel cell, according to some embodiments of the inventive concepts.

### DETAILED DESCRIPTION OF THE EMBODIMENTS

The inventive concepts will now be described more fully hereinafter with reference to the accompanying drawings, in which exemplary embodiments of the inventive concepts are shown. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts.

It will be understood that when an element such as a layer, region or substrate is referred to as being “on” another element, it can be directly on the other element or intervening elements may be present. In addition, in the drawings, the thicknesses of layers and regions are exaggerated for clarity.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concepts explained and illustrated herein include their complementary counterparts. As used herein, the term “and/or” includes any and all combinations of one or more of the associated listed items.

The terminology used herein is for the purpose of describing particular embodiments only and is not intended to limit the invention. As used herein, the singular terms “a”, “an” and “the” are intended to include the plural forms as well, unless the context clearly indicates otherwise. It will be further understood that the terms “comprises”, “comprising”, “includes”, “including”, “have”, “has” and/or “having” when used herein, specify the presence of stated features, integers, steps, operations, elements, and/or components, but do not preclude the presence or addition of one or more other features, integers, steps, operations, elements, components, and/or groups thereof. Furthermore, it will be understood that when an element is referred to as being “connected” or “coupled” to another element, it may be directly connected or coupled to the other element or intervening elements may be present.

In addition, in explanation of the present invention, the descriptions to the elements and functions of related arts may be omitted if they obscure the subjects of the inventive concepts.

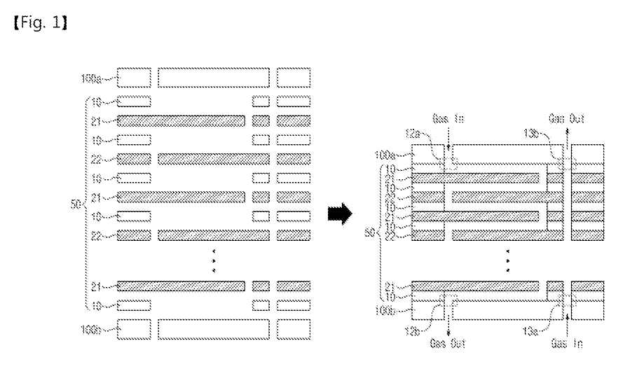

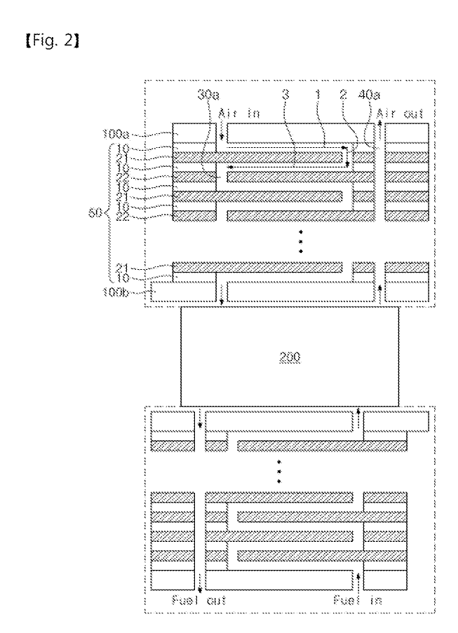

FIG. 1 is a schematic view illustrating a method of manufacturing a gas heating unit for a fuel cell, according to an embodiment of the inventive concepts, and FIG. 2 is a schematic view illustrating a process of supplying/exhausting a supply gas and an exhaust gas into/from a fuel cell stack module through a gas heating unit for a fuel cell, according to an embodiment of the inventive concepts.

Referring to FIGS. 1 and 2, a gas heating unit 50 for a fuel cell according to an embodiment of the inventive concepts may be formed by alternately stacking pre-heating plates 21 and 22 and support plates 10. Openings may be formed in the pre-heating plates 21 and 22 and the support plates 10.

According to an embodiment, the gas heating unit 50 may be coupled to one side surface of a fuel cell stack module 200 by a pressing means pressing the gas heating unit 50 in the stacking direction. The pressing means may include a stack-pressing metal plate 100a for bringing unit stacks of the fuel cell stack module 200 into close contact with each other, and a current-collecting metal plate 100b for collecting a current generated from the fuel cell stack module 200.

The gas heating unit 50 may include a supply gas inlet 12a, a supply gas outlet 12b, the support plates 10, the pre-heating plates 21 and 22, an exhaust gas inlet 13a, and an exhaust gas outlet 13b.

The supply gas inlet 12a may be formed at a position at which a path formed in the stack-pressing metal plate 100a is connected to the opening of the support plate 10. A supply gas may flow from the outside into the gas heating unit 50 through the path of the stack-pressing metal plate 100a and the supply gas inlet 12a.

In an embodiment, the supply gas may be air or fuel. The supply gas may be a reaction gas which is supplied into the fuel cell stack module 200 to produce electric energy.

The supply gas outlet 12b may be formed at a position at which a path formed in the current-collecting metal plate 100b is connected to the opening of the support plate 10. The supply gas may flow from the gas heating unit 50 into the fuel cell stack module 200 through the path of the current-collecting metal plate 100b and the supply gas outlet 12b. In an embodiment, the supply gas may be the air or the fuel, as described above.

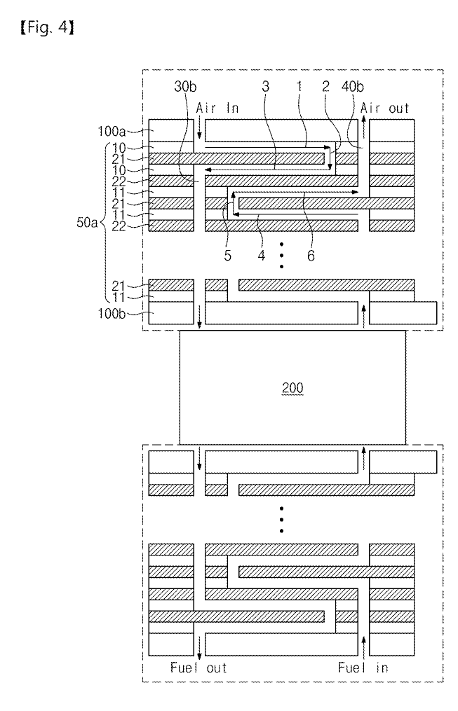

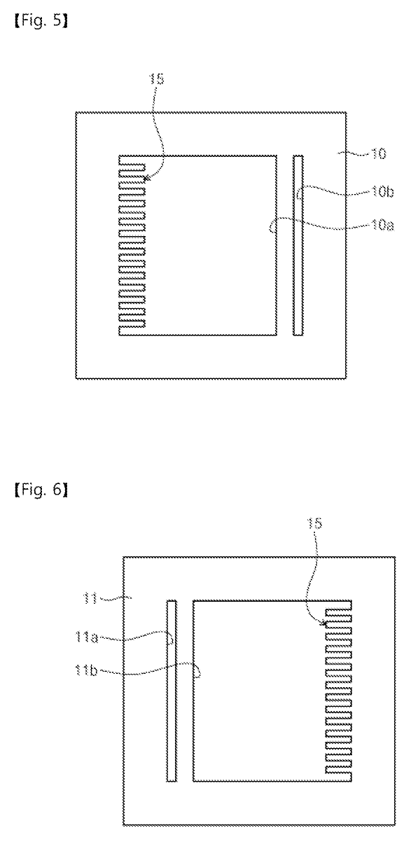

The support plates 10 and the pre-heating plates 21 and 22 may be alternately stacked between the stack-pressing metal plate 100a and the current-collecting metal plate 100b. FIG. 5 illustrates a plan view of the support plate 10. Referring to FIGS. 1, 2 and 5, each of the support plates 10 may include a first opening 10a and a second opening 10b. The first opening 10a of the support plate 10 disposed between one pre-heating plate 21 and another pre-heating plate 22 of the pre-heating plates 21 and 22 may provide a supply gas path 30a through which the supply gas flows from the outside to the fuel cell stack module 200. The supply gas path 30a may extend in an extending direction of the pre-heating plate 21 or 22.

The second opening 10b of the support plate 10 disposed between the one pre-heating plate 21 and the other pre-heating plate 22 of the pre-heating plates 21 and 22 may provide an exhaust gas path 40a through which a high-temperature exhaust gas flows from the fuel cell stack module 200 to the outside. The exhaust gas path 40a may extend in a thickness direction of the pre-heating plate 21 or 22.

According to an embodiment, shapes of the first openings 10a of the support plates 10 providing the supply gas path 30a may be different from those of the second openings 10b of the support plates 10 providing the exhaust gas path 40a, and an area of the first opening 10a may be greater than that of the second opening 10b.

Since the support plates 10 support the pre-heating plates 21 and 22, it is possible to minimize or prevent physical deformation and/or breakage of the pre-heating plates 21 and 22. In other words, the pre-heating plates 21 and 22 having thin thicknesses and the support plates 10 may be alternately stacked to improve thermal conductivity. The pre-heating plates 21 and 22 may be vulnerable to a thermal shock due to their thin thicknesses. A temperature of the supply gas flowing through the supply gas path 30a may be different from a temperature of the exhaust gas flowing through the exhaust gas path 40a, and thus the supply gas and the exhaust gas may continuously apply the thermal shock to the pre-heating plates 21 and 22. However, since the support plates 10 support the pre-heating plates 21 and 22, it is possible to minimize physical damage of the pre-heating plates 21 and 22 which may be caused by the thermal shock.

According to an embodiment, to effectively support the pre-heating plates 21 and 22, a cut-off pattern 15 may be included in the first opening 10a and/or the second opening 10b of each of the support plates 10. When the support plates 10 and the pre-heating plates 21 and 22 are alternately stacked, the cut-off patterns 15 formed in the support plates 10 may not overlap with the openings of the pre-heating plates 21 and 22. In other words, an area (or a width) of a portion, having the cut-off pattern 15, of the support plate 10 may be less than an area (or a width) of the pre-heating plate 21 or 22 on the portion of the support plate 10 which has the cut-off pattern 15. The cut-off pattern 15 may increase a contact area of the supply gas and the pre-heating plate 21 or 22, and thus efficiency of pre-heating of the supply gas may be improved.

As described above, the pre-heating plates 21 and 22 may be alternately stacked with the support plates 10 between the stack-pressing metal plate 100a and the current-collecting metal plate 100b. Referring to FIGS. 7 and 9 illustrating plan views of the pre-heating plates 21 and 22, the pre-heating plates 21 and 22 may include a plurality of first pre-heating plates 21 and a plurality of second pre-heating plates 22. Each of the first pre-heating plates 21 may include a third opening 21c and a fourth opening 21d, and each of the second pre-heating plates 22 may include a fifth opening 22e and a sixth opening 22f.

The third opening 21c of the first pre-heating plate 21 between adjacent two of the support plates 10 and the fifth opening 22e of the second pre-heating plate 22 between adjacent two of the support plates 10 may provide the supply gas path 30a of the supply gas flowing from the outside to the fuel cell stack module 200, like the first opening 10a of the support plate 10. The portions of the supply gas path 30a corresponding to the third and fifth openings 21c and 22e may extend in the thickness direction of the pre-heating plates 21 and 22.

The fourth opening 21d of the first pre-heating plate 21 between adjacent two of the support plates 10 and the sixth opening 22f of the second pre-heating plate 22 between adjacent two of the support plates 10 may provide the exhaust gas path 40a of the high-temperature exhaust gas flowing from the fuel cell stack module 200 to the outside, like the second opening 10b of the support plate 10. The portions of the exhaust gas path 40a corresponding to the fourth and sixth openings 21d and 22f may extend in the thickness direction of the pre-heating plates 21 and 22.

According to an embodiment, shapes and areas of the fourth and sixth openings 21d and 22f of the pre-heating plates 21 and 22 may be substantially the same as shapes and areas of the second openings 10b of the support plates 10.

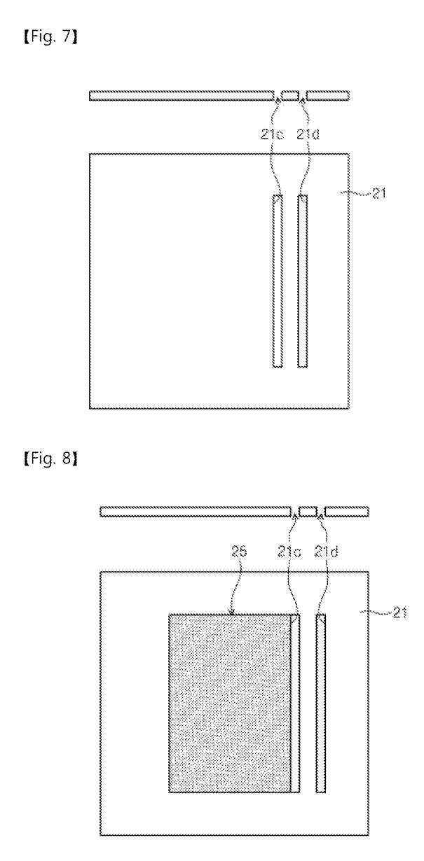

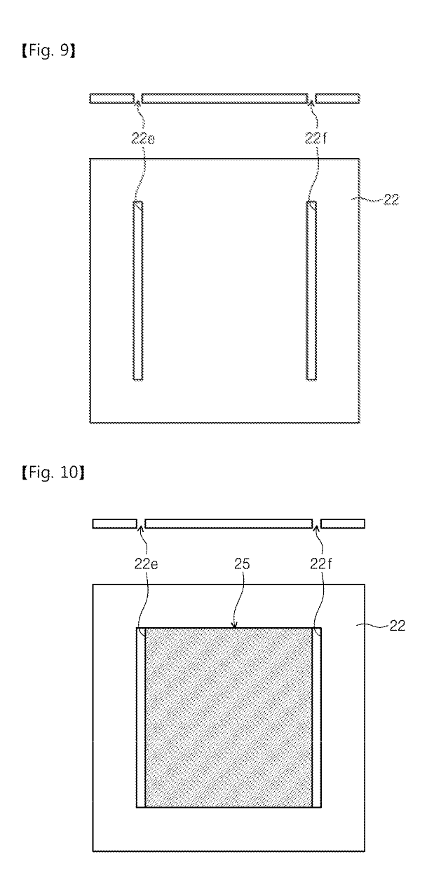

In addition, referring to FIGS. 8 and 10, when the supply gas is the fuel, catalyst layers 25 for reforming the fuel may be formed on surfaces of the pre-heating plates 21 and 22. The catalyst layer 25 may be formed on a part or the whole of each of remaining portions of the pre-heating plates 21 and 22 except portions of the pre-heating plates 21 and 22 in which the openings exist. A process in which the fuel flows through the supply gas path 30a along the catalyst layers 25 formed on the surfaces of the pre-heating plates 21 and 22 may be repeated, and thus reforming efficiency of the fuel supplied into the fuel cell stack module 200 may be improved.

In addition, since the pre-heating plates 21 and 22 are stacked with the support plates 10 interposed therebetween, the catalyst layer 25 may be easily formed on the surface of each of the pre-heating plates 21 and 22. In other words, individual pre-heating plates 21 and 22 on which the catalyst layers 25 are respectively formed may be prepared, and then, the pre-heating plates 21 and 22 and the support plates 10 may be alternately stacked. Thus, it is possible to easily provide the gas heating unit 50 which includes the pre-heating plates 21 and 22 having the catalyst layers 25.

According to an embodiment, the catalyst layer 25 may include at least one of zirconia (YSZ), nickel (Ni), copper (Cu), zinc oxide (ZnO), aluminum oxide (Al₂O₃), palladium (Pd), zirconium oxide (ZrO₂), cerium oxide (CeO₂), chromium oxide (Cr₂O₃), or rhodium (Rh).

The exhaust gas inlet 13a may be formed at a position at which a path formed in the current-collecting metal plate 100b is connected to the opening (e.g., the second opening 10b) of the support plate 10, like the supply gas outlet 12b. The high-temperature exhaust gas exhausted from the fuel cell stack module 200 may be exhausted to the outside through the path of the current-collecting metal plate 100b and the exhaust gas inlet 13a. In an embodiment, the exhaust gas may be air or fuel.

The exhaust gas outlet 13b may be formed at a position at which a path formed in the stack-pressing metal plate 100a is connected to the opening (e.g., the second opening 10b) of the support plate 10, like the supply gas inlet 12a. The high-temperature exhaust gas exhausted from the fuel cell stack module 200 may be exhausted to the outside through the exhaust gas outlet 13b and the path of the stack-pressing metal plate 100a. In an embodiment, the exhaust gas may be the air or the fuel, as described above.

As described above, the openings of the support plates 10 and the openings of the pre-heating plates 21 and 22 may provide the supply gas path 30a and the exhaust gas path 40a in the gas heating unit 50.

Referring to FIG. 2, the supply gas path 30a may include a first flow section 1 in which the supply gas flows in a first direction (i.e., the extending direction of the first pre-heating plate 21) along the surface of the first pre-heating plate 21 through the first opening 10a of one of the support plates 10, a second flow section 2 in which the supply gas flows in a second direction (i.e., the thickness direction of the first pre-heating plate 21) through the third opening 21c of the first pre-heating plate 21, and a third flow section 3 in which the supply gas flows in a third direction opposite to the first direction along the surface of the second pre-heating plate 22 through the first opening 10a of another support plate 10 adjacent to the one support plate 10. The first, second and third flow sections 1, 2 and 3 may constitute a basic unit section, and the supply gas path 30a may include a plurality of the basic unit sections repeatedly formed.

On the other hand, the exhaust gas path 40a may be formed to extend in one direction, unlike the supply gas path 30a. In more detail, the second openings 10b of the support plates 10, the fourth openings 21d of the first pre-heating plates 21 and the sixth openings 22f of the second pre-heating plates 22, which have the same shapes and sizes, may be connected to each other to form the exhaust gas path 40a. Thus, the exhaust gas path 40a may be formed to extend from the exhaust gas inlet 13a to the exhaust gas outlet 13b in the one direction.

In addition, as described above, the gas heating unit 50 may be coupled to one side surface of the fuel cell stack module 200 by the pressing means pressing the gas heating unit 50 in the stacking direction. The fuel cell unit stacks included in the fuel cell stack module 200, the support plates 10 and the pre-heating plates 21 and 22 may be pressed in the same direction as the stacking direction thereof by the pressing means (e.g., the stack-pressing metal plate 100a and the current-collecting metal plate 100b), thereby improving adherency of the fuel cell unit stacks of the fuel cell stack module 200, the support plates 10 and the pre-heating plates 21 and 22.

Referring to FIG. 2, two gas heating units 50 may be coupled to the one side surface and another side surface of the fuel cell stack module 200, respectively. The other side surface may be opposite to the one side surface. In the gas heating unit 50 coupled to the one side surface of the fuel cell stack module 200, the air provided from the outside may flow through the supply gas path 30a and may be pre-heated by the pre-heating plates 21 and 22, and the pre-heated air may be supplied into the fuel cell stack module 200. Thus, a thermal shock of the supplied air to the fuel cell stack module 200 may be minimized to minimize physical damage of the fuel cell stack module 200. In addition, high-temperature air provided from the fuel cell stack module 200 may be exhausted to the outside through the exhaust gas path 40a of the gas heating unit 50 coupled to the one side surface of the fuel cell stack module 200.

On the other hand, in the gas heating unit 50 coupled to the other side surface of the fuel cell stack module 200, the fuel provided from the outside may flow through the supply gas path 30a and may be pre-heated by the pre-heating plates 21 and 22, and the pre-heated fuel may be supplied into the fuel cell stack module 200. Thus, a thermal shock of the supplied fuel to the fuel cell stack module 200 may be minimized to minimize physical damage of the fuel cell stack module 200. In addition, high-temperature fuel provided from the fuel cell stack module 200 may be exhausted to the outside through the exhaust gas path 40a of the gas heating unit 50 coupled to the other side surface of the fuel cell stack module 200.

According to an embodiment, temperatures of the pre-heating plates 21 and 22 may be higher than a temperature of the supply gas provided from the outside to the fuel cell stack module 200.

The gas heating unit 50 according to the embodiment of the inventive concepts was described above. A gas heating unit according to another embodiment of the inventive concepts will be described hereinafter.

In a gas heating unit 50a according to another embodiment of the inventive concepts, an exhaust gas path 40b may not extend in one direction but may intersect a supply gas path 30b, unlike the exhaust gas path 40a according to the above embodiment. In the gas heating unit 50 according to the above embodiment, the supply gas flowing through the supply gas path 30a may be pre-heated by only the pre-heating plates 21 and 22. However, in the gas heating unit 50a according to the present embodiment, the supply gas flowing through the supply gas path 30b may be pre-heated by the pre-heating plates 21 and 22 and may also be pre-heated by a heat exchange with the high-temperature exhaust gas flowing through the exhaust gas path 40b intersecting the supply gas path 30b.

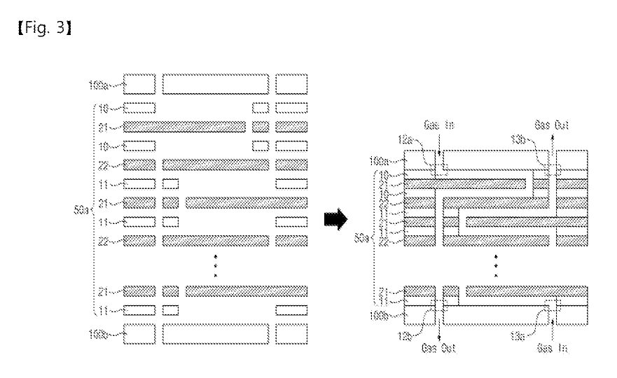

FIG. 3 is a schematic view illustrating a method of manufacturing a gas heating unit for a fuel cell, according to another embodiment of the inventive concepts, and FIG. 4 is a schematic view illustrating a process of supplying/exhausting a supply gas and an exhaust gas into/from a fuel cell stack module through a gas heating unit for a fuel cell, according to another embodiment of the inventive concepts. In the present embodiment of FIGS. 3 and 4, the descriptions to the same technical features as in the above embodiment of FIGS. 1 and 2 will be omitted or mentioned briefly for the purpose of ease and convenience in explanation.

Referring to FIGS. 3 and 4 in addition to FIGS. 1 and 2, the gas heating unit 50a according to the present embodiment may be formed by alternately stacking pre-heating plates 21 and 22 having openings and support plates 10 and 11 having openings between the stack-pressing metal plate 100a and the current-collecting metal plate 100b, like the gas heating unit 50 according to the above embodiment. However, the gas heating unit 50a according to the present embodiment may further include support plates 11 which have bilaterally symmetrical structures with the support plates 10 according to the above embodiment.

Referring to FIG. 6, shapes and areas of first openings 11a of the support plates 11 having the bilaterally symmetrical structures according to the present embodiment may be substantially the same as the shapes and the areas of the second openings 10b of the support plates 10 according to the above embodiments, and shapes and areas of second openings 11b of the support plates 11 having the bilaterally symmetrical structures according to the present embodiment may be substantially the same as the shapes and the areas of the first openings 10a of the support plates 10 according to the above embodiment. Thus, in the support plates 11 having the bilaterally symmetrical structures, the areas of the first openings 11a may be less than the areas of the second openings 11b.

In addition, the first openings 11a of the support plates 11 having the bilaterally symmetrical structures, the first openings 10a of the support plates 10 and the third and fifth openings 21c and 22e of the first and second pre-heating plates 21 and 22 may provide the supply gas path 30b through which the supply gas flows from the outside to the fuel cell stack module 200. In this case, the areas of the first openings 10a of the support plates 10 providing the supply gas path 30b may be greater than the areas of the first openings 11a of the support plates 11 having the bilaterally symmetrical structures and providing the supply gas path 30b. The second openings 11b of the support plates 11 having the bilaterally symmetrical structures, the second openings 10b of the support plates 10 and the fourth and sixth openings 21d and 22f of the first and second pre-heating plates 21 and 22 may provide the exhaust gas path 40b through which the high-temperature exhaust gas flows from the fuel cell stack module 200 to the outside. In this case, the areas of the second openings 10b of the support plates 10 providing the exhaust gas path 40b may be less than the areas of the second openings 11b of the support plates 11 having the bilaterally symmetrical structures and providing the exhaust gas path 40b.

Referring to FIG. 4, as described in the gas heating unit 50 according to the above embodiment, the supply gas path 30b may include a first flow section 1 in which the supply gas flows in a first direction (i.e., the extending direction of the first pre-heating plate 21) along the surface of the first pre-heating plate 21 through the first opening 10a of one of the support plates 10, a second flow section 2 in which the supply gas flows in a second direction (i.e., the thickness direction of the first pre-heating plate 21) through the third opening 21c of the first pre-heating plate 21, and a third flow section 3 in which the supply gas flows in a third direction opposite to the first direction along the surface of the second pre-heating plate 22 through the first opening 10a of another support plate 10 adjacent to the one support plate 10. The first, second and third flow sections 1, 2 and 3 may constitute a basic unit section, and the supply gas path 30b may include a plurality of the basic unit sections repeatedly formed.

On the other hand, the exhaust gas path 40b may be formed to intersect the supply gas path 30b, unlike the exhaust gas path 40a of the gas heating unit 50 according to the above embodiment. In more detail, the exhaust gas path 40b may include a fourth flow section 4 in which the exhaust gas flows in an extending direction (i.e., the third direction) of the first pre-heating plate 21 along the surface of the first pre-heating plate 21 through the second opening 11b of one of the support plates 11 having the bilaterally symmetrical structures, a fifth flow section 5 in which the exhaust gas flows in a thickness direction (i.e., a direction opposite to the second direction) of the first pre-heating plate 21 through the fourth opening 21d of the first pre-heating plate 21, and a sixth flow section 6 in which the exhaust gas flows in a direction (i.e., the first direction) opposite to the flowing direction in the fourth flow section 4 along the surface of the second pre-heating plate 22 through the second opening 11b of another support plate 11 of the bilaterally symmetrical structure adjacent to the one support plate 11. The fourth, fifth and sixth flow sections 4, 5 and 6 may constitute a basic unit section, and the exhaust gas path 40b may include a plurality of the basic unit sections repeatedly formed. Thus, a flowing direction (e.g., the third direction) of the supply gas flowing through the supply gas path 30b (e.g., the third flow section 3) may be opposite to a flowing direction (e.g., the first direction) of the exhaust gas flowing through the exhaust gas path 40b (e.g., the sixth flow section 6).

In the case in which the exhaust gas path 40b intersects the supply gas path 30b in the extending direction of the pre-heating plate 21 or 22, the supply gas flowing through the supply gas path 30b may be pre-heated by the pre-heating plates 21 and 22 and the high-temperature exhaust gas flowing through the exhaust gas path 40b intersecting the supply gas path 30b, as described above. Thus, the supply gas supplied to the fuel cell stack module 200 may be easily pre-heated.

According to an embodiment, the temperature of the exhaust gas may be higher than those of the pre-heating plates 21 and 22, and the temperatures of the pre-heating plates 21 and 22 may be higher than that of the supply gas. Thus, it is possible to prevent inefficient heat transfer in the gas heating unit 50a (e.g., inefficient heat transfer from the pre-heating plates 21 and 22 to the exhaust gas when temperatures of the pre-heating plates 21 and 22 are higher than that of the exhaust gas).

In addition, the gas heating unit 50a according to the present embodiment may be coupled to one side surface of the fuel cell stack module 200 by a pressing means pressing the gas heating unit 50a in the stacking direction, as described with reference to the gas heating unit 50 according to the above embodiment. Thus, it is possible to improve adherency of the fuel cell unit stacks of the fuel cell stack module 200, the support plates 10 and 11 and the pre-heating plates 21 and 22.

Referring to FIG. 4, two gas heating units 50a may be coupled to the one side surface and another side surface of the fuel cell stack module 200, respectively. The other side surface may be opposite to the one side surface. In the gas heating unit 50a coupled to the one side surface of the fuel cell stack module 200, the air provided from the outside may flow through the supply gas path 30b and may be pre-heated by the pre-heating plates 21 and 22 and high-temperature air flowing through the exhaust gas path 40b, and the pre-heated air may be supplied into the fuel cell stack module 200. Thus, a thermal shock of the supplied air to the fuel cell stack module 200 may be minimized to minimize physical damage of the fuel cell stack module 200. In addition, the high-temperature air provided from the fuel cell stack module 200 may be exhausted to the outside through the exhaust gas path 40b of the gas heating unit 50a coupled to the one side surface of the fuel cell stack module 200.

On the other hand, in the gas heating unit 50a coupled to the other side surface of the fuel cell stack module 200, the fuel provided from the outside may flow through the supply gas path 30b and may be pre-heated by the pre-heating plates 21 and 22 and high-temperature fuel flowing through the exhaust gas path 40b, and the pre-heated fuel may be supplied into the fuel cell stack module 200. Thus, a thermal shock of the supplied fuel to the fuel cell stack module 200 may be minimized to minimize physical damage of the fuel cell stack module 200. In addition, the high-temperature fuel provided from the fuel cell stack module 200 may flow through the exhaust gas path 40b of the gas heating unit 50a coupled to the other side surface of the fuel cell stack module 200 and may be exhausted to the outside while pre-heating the fuel flowing through the supply gas path 30b, as described above. According to an embodiment, the temperatures of the pre-heating plates 21 and 22 may be higher than that of the supply gas.

In addition, when the supply gas is the fuel, catalyst layers 25 for reforming the fuel may be formed on the surfaces of the pre-heating plates 21 and 22 of the gas heating unit 50a according to the present embodiment, as described with reference to the gas heating unit 50 according to the above embodiment. A process in which the fuel flows through the supply gas path 30b along the catalyst layers 25 formed on the surfaces of the pre-heating plates 21 and 22 may be repeated, and thus reforming efficiency of the fuel supplied into the fuel cell stack module 200 may be improved.

Moreover, since the pre-heating plates 21 and 22 are stacked with the support plates 10 and 11 interposed therebetween, the catalyst layer 25 may be easily formed on the surface of each of the pre-heating plates 21 and 22, as described with reference to the gas heating unit 50 according to the above embodiment. In other words, individual pre-heating plates 21 and 22 on which the catalyst layers 25 are respectively formed may be prepared, and then, the pre-heating plates 21 and 22 and the support plates 10 and 11 may be alternately stacked. Thus, it is possible to easily provide the gas heating unit 50a which includes the pre-heating plates 21 and 22 having the catalyst layers 25.

Hereinafter, a fuel cell stack 500 according to some embodiments of the inventive concepts will be described. The fuel cell stack 500 may include the gas heating unit 50 and/or 50a according to the above embodiments, which is coupled to the fuel cell stack module 200 by the stack-pressing metal plate 100a and the current-collecting metal plate 100b.

FIG. 11 is a perspective view illustrating a fuel cell stack including a gas heating unit for a fuel cell, according to some embodiments of the inventive concepts.

As described with reference to FIGS. 2 and 4, the fuel cell stack 500 may include the fuel cell stack module 200, the stack-pressing metal plate 100a, the gas heating unit 50 or 50a according to the above embodiments, and the current-collecting metal plate 100b.

The fuel cell stack module 200 may be formed by stacking one or more unit stacks, each of which includes a single cell, a gas separation plate, and a sealing material. In other words, the fuel cell stack module 200 may include a single unit stack or a plurality of the stacked unit stacks. Here, a stacking direction of the unit stacks may be the same as the stacking direction of the support plates 10 and 11 and the pre-heating plates 21 and 22.

In addition, the fuel cell stack module 200 may be covered with a heat resistant material. Thus, a high temperature of the fuel cell stack module 200 operating at the high temperature may be maintained to improve operating efficiency of the fuel cell stack module 200. Moreover, an entrance for receiving and exhausting the air may be formed at one side surface of the fuel cell stack module 200, and an entrance for receiving and exhausting the fuel may be formed at another side surface, opposite to the one side surface, of the fuel cell stack module 200. The air may move between the fuel cell stack module 200 and the gas heating unit 50 or 50a coupled to the one side surface of the fuel cell stack module 200 through the entrance for receiving and exhausting the air. In addition, the fuel may move between the fuel cell stack module 200 and the gas heating unit 50 or 50a coupled to the other side surface, opposite to the one side surface, of the fuel cell stack module 200 through the entrance for receiving and exhausting the fuel.

The current-collecting metal plates 100b may be formed on the one side surface and the other side surface of the fuel cell stack module 200, respectively. The paths of the current-collecting metal plates 100b described with reference to FIGS. 1 and 2 may be connected to the entrances for receiving and exhausting the air and the fuel formed at the one side surface and the other side surface of the fuel cell stack module 200 and may be connected to the supply gas outlets 12b and the exhaust gas inlets 13a of the gas heating units 50 or 50a. The current-collecting metal plates 100b may collect a current generated in the fuel cell stack module 200 and may increase the adherency of the unit stacks of the fuel cell stack module 200 and the support plates 10 and 11 and the pre-heating plates 21 and 22 of the gas heating units 50 or 50a.

The gas heating units 50 or 50a according to the above embodiments may be respectively formed on the current-collecting metal plates 100b formed on the one side surface and the other side surface, opposite to the one side surface, of the fuel cell stack module 200. The air may be pre-heated through the gas heating unit 50 or 50a formed on the one side surface of the fuel cell stack module 200 and then may be supplied into the fuel cell stack module 200, and high-temperature air reacted in the fuel cell stack module 200 may be exhausted to the gas heating unit 50 or 50a. In addition, the fuel may be pre-heated through the gas heating unit 50 or 50a formed on the other side surface, opposite to the one side surface, of the fuel cell stack module 200 and then may be supplied into the fuel cell stack module 200. High-temperature fuel reacted in the fuel cell stack module 200 may be exhausted to the gas heating unit 50 or 50a.

The stack-pressing metal plates 100a may be formed on the gas heating units 50 or 50a disposed on the one side surface and the other side surface of the fuel cell stack module 200, respectively. The stack-pressing metal plates 100a may be opposite to the current-collecting metal plates 100b with the gas heating units 50 or 50a interposed therebetween, respectively. The paths of the stack-pressing metal plates 100a described with reference to FIGS. 1 and 2 may be connected to the supply gas inlets 12a and the exhaust gas outlets 13b of the gas heating units 50 or 50a. The stack-pressing metal plates 100a and the current-collecting metal plates 100b may press the fuel cell stack module 200 and the gas heating units 50 or 50a to improve the adherency of the unit stacks of the fuel cell stack module 200 and the support plates 10 and 11 and the pre-heating plates 21 and 22 of the gas heating units 50 or 50a.

As illustrated in FIG. 11, the fuel cell stack 500 may further include bolts and nuts which connect or couple the stack-pressing metal plates 100a and the current-collecting metal plates 100b to each other. The stack-pressing metal plates 100a and the current-collecting metal plates 100b may be strongly pressed using the bolts and the nuts to easily adhere the unit stacks of the fuel cell stack module 200 and the support plates 10 and 11 and the pre-heating plates 21 and 22 of the gas heating units 50 or 50a.

A power-generating fuel cell stack using the fuel cell stack including at least one of the gas heating units according to the above embodiments will be described hereinafter.

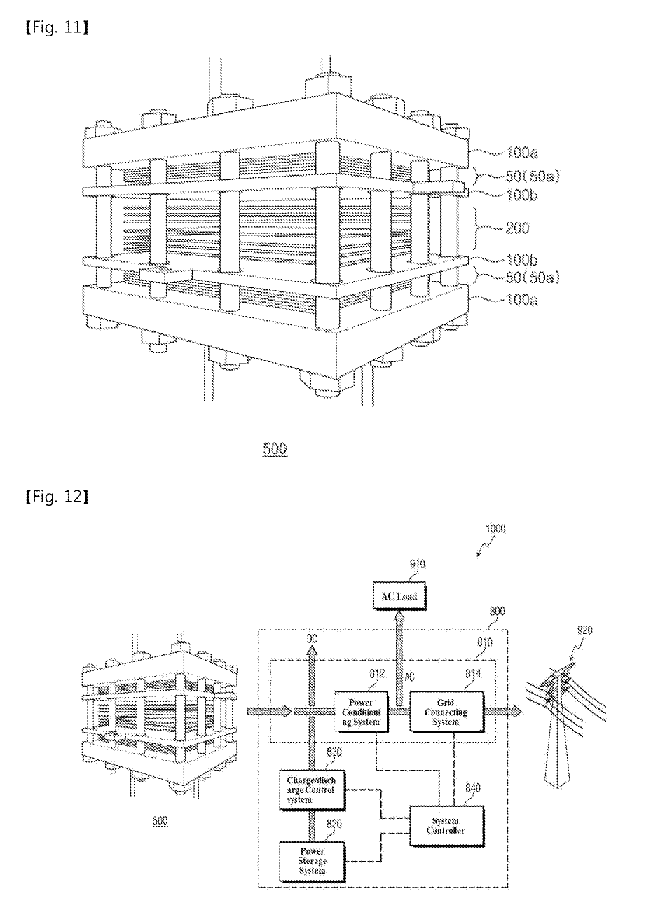

FIG. 12 is a view illustrating an application example of a power-generating fuel cell stack which uses a fuel cell stack including a gas heating unit for a fuel cell, according to some embodiments of the inventive concepts.

Referring to FIG. 12, a power-generating fuel cell stack 1000 may include a power control system 800 which is supplied with power (i.e., electric power) from the fuel cell stack 500 including the gas heating unit 50 or 50a according to the above embodiments of the inventive concepts and transmits the power to the outside. The power control system 800 may include an output system 810, a power storage system 820, a charge/discharge control system 830, and a system controller 840. The output system 810 may include a power conditioning system (PCS) 812.

The power conditioning system 812 may be an inverter that converts a direct current (DC) supplied from the fuel cell stack 500 into an alternating current (AC). The charge/discharge control system 830 may store the power supplied from the fuel cell stack 500 in the power storage system 820 and/or may output the power stored in the power storage system 820 to the output system 810. The system controller 840 may control the output system 810, the power storage system 820, and the charge/discharge control system 830.

The converted alternating current may be supplied to and used in various AC loads 910 such as cars and homes. In addition, the output system 810 may further include a grid connecting system 814. The grid connecting system 814 may be connected to another power system 920 and may transmit the power to the outside via the other power system 920.

Unlike the embodiments of the inventive concepts, a typical fuel cell stack may include a fuel cell stack module including stacked unit stacks, each of which includes a single cell, a gas separation plate and a sealing material; a current-collecting metal plate disposed on the fuel cell stack module to collect a current generated from the fuel cell stack module, and a stack-pressing metal plate disposed on the current-collecting metal plate to adhere the unit stacks in the fuel cell stack module. In this case, fuel or air which is not pre-heated may be supplied directly to the fuel cell stack module operated at a high temperature, and thus physical deformation and/or breakage of the fuel cell stack module may occur by a thermal shock.

However, in the fuel cell stack 500 according to the embodiments of the inventive concepts, the gas heating unit 50 or 50a may be formed between the stack-pressing metal plate 100a and the current-collecting metal plate 100b formed on the fuel cell stack module 200. The gas heating unit 50 or 50a may include the support plates 10 and 11 and the pre-heating plates 21 and 22 which are alternately stacked. The pre-heating plates 21 and 22 may have the openings and may pre-heat the supply gas (e.g., the fuel or the air) supplied to the fuel cell stack module 200, and the support plates 10 and 11 may have the openings and may support the pre-heating plates 21 and 22.

The openings of the support plates 10 and 11 and the openings of the pre-heating plates 21 and 22 may be connected to each other to provide the supply gas path 30a or 30b for supplying the supply gas from the outside to the fuel cell stack module 200 and the exhaust gas path 40a or 40b for exhausting the high-temperature exhaust gas (e.g., the air or the fuel) from the fuel cell stack module 200 to the outside. In the case in which the exhaust gas path 40a of the gas heating unit 50 is formed to extend in one direction (e.g., the thickness direction of the pre-heating plates 21 and 22), the supply gas flowing through the supply gas path 30a of the gas heating unit 50 may be pre-heated by the pre-heating plates 21 and 22 of the gas heating unit 50 and then may be supplied into the fuel cell stack module 200.

In the case in which the exhaust gas path 40b of the gas heating unit 50a is formed to intersect the supply gas path 30b, the supply gas flowing through the supply gas path 30b of the gas heating unit 50a may be pre-heated by the pre-heating plates 21 and 22 of the gas heating unit 50a and the high-temperature exhaust gas flowing through the exhaust gas path 40b. Thus, a thermal shock of the supply gas to the fuel cell stack module 200 may be minimized to minimize physical damage of the fuel cell stack module 200.

In addition, the fuel cell unit stacks included in the fuel cell stack module 200, the support plates 10 and 11 and the pre-heating plates 21 and 22 may be pressed in the same direction as the stacking direction thereof by the pressing means (e.g., the stack-pressing metal plate 100a and the current-collecting metal plate 100b), thereby improving the adherency of the fuel cell unit stacks of the fuel cell stack module 200, the support plates 10 and 11 and the pre-heating plates 21 and 22.

Moreover, when the supply gas is the fuel, the catalyst layers 25 for reforming the fuel may be formed on the surfaces of the pre-heating plates 21 and 22. The process in which the fuel flows through the supply gas path 40a or 40b along the catalyst layers 25 formed on the surfaces of the pre-heating plates 21 and 22 may be repeated, and thus the reforming efficiency of the fuel supplied into the fuel cell stack module 200 may be improved.

Furthermore, since the pre-heating plates 21 and 22 are stacked with the support plates 10 and 11 interposed therebetween, the catalyst layer 25 may be easily formed on the surface of each of the pre-heating plates 21 and 22. In other words, individual pre-heating plates 21 and 22 on which the catalyst layers 25 are respectively formed may be prepared, and then, the pre-heating plates 21 and 22 and the support plates 10 and 11 may be alternately stacked. Thus, it is possible to easily provide the gas heating unit 50 or 50a which includes the pre-heating plates 21 and 22 having the catalyst layers 25.

The embodiments of the inventive concepts may be applied to a fuel cell, and more particularly, to a fuel cell stack.

While the inventive concepts have been described with reference to exemplary embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A gas heating unit for a fuel cell, comprising:
a supply gas inlet for receiving a supply gas before pre-heating;
a plurality of pre-heating plates having openings and configured to pre-heat the supply gas;
a plurality of support plates supporting the pre-heating plates and having openings; and
a supply gas outlet for supplying the pre-heated supply gas to a fuel cell stack module,
wherein the pre-heating plates and the support plates are alternately stacked, and the openings of the pre-heating plates and the openings of the support plates provide a path to the supply gas.

2. The gas heating unit for a fuel cell of claim 1, wherein the opening of the support plate disposed between one pre-heating plate and another pre-heating plate of the plurality of pre-heating plates provides a section of a supply gas path for the supply gas, which extends in an extending direction of the pre-heating plate, and
wherein the opening of the pre-heating plate disposed between one support plate and another support plate of the plurality of support plates provides another section of the supply gas path for the supply gas, which extends in a thickness direction of the pre-heating plate.

3. The gas heating unit for a fuel cell of claim 2, wherein the supply gas path includes: a first flow section in which the supply gas flows in a first direction along a surface of the pre-heating plate through the opening of one of the plurality of support plates; a second flow section in which the supply gas flows in a second direction parallel to the thickness direction of the pre-heating plate through the opening of the pre-heating plate; and a third flow section in which the supply gas flows in a third direction opposite to the first direction along a surface of the pre-heating plate through the opening of another support plate adjacent to the one support plate.

4. The gas heating unit for a fuel cell of claim 3, wherein the first, second and third flow sections constitute a basic unit section, and the supply gas path includes a plurality of the basic unit sections.

5. The gas heating unit for a fuel cell of claim 2, wherein the plurality of pre-heating plates and the plurality of support plates further include openings for an exhaust gas path through which a high-temperature exhaust gas exhausted from the fuel cell stack module flows.

6. The gas heating unit for a fuel cell of claim 5, wherein the exhaust gas path extends in one direction.

7. The gas heating unit for a fuel cell of claim 6, wherein areas of the openings of the support plates providing the supply gas path are greater than areas of the openings of the support plates providing the exhaust gas path.

8. The gas heating unit for a fuel cell of claim 5, wherein the exhaust gas path intersects the supply gas path in the extending direction of the pre-heating plate such that the high-temperature exhaust gas flowing through the exhaust gas path pre-heats the supply gas.

9. The gas heating unit for a fuel cell of claim 8, wherein a flowing direction of the exhaust gas flowing through the exhaust gas path is opposite to a flowing direction of the supply gas flowing through the supply gas path with the pre-heating plate interposed therebetween.

10. The gas heating unit for a fuel cell of claim 9, wherein a temperature of the exhaust gas flowing through the exhaust gas path is higher than a temperature of the pre-heating plate, and the temperature of the pre-heating plate is higher than a temperature of the supply gas flowing through the supply gas path.

11. The gas heating unit for a fuel cell of claim 1, wherein the supply gas includes fuel, and
wherein a catalyst layer for reforming the fuel is formed on a surface of the pre-heating plate along which the supply gas including the fuel flows.

12. The gas heating unit for a fuel cell of claim 1, wherein the support plate includes a cut-off pattern for supporting the pre-heating plate, and
wherein the cut-off pattern of the support plate does not overlap with the opening of the pre-heating plate stacked on the support plate.

13. A fuel cell stack comprising:
the gas heating unit for a fuel cell of claim 1,
wherein the gas heating unit for a fuel cell is coupled to the fuel cell stack module by a pressing means pressing the gas heating unit in a stacking direction of the pre-heating plates and the support plates.
